(19) United States
(12) Patent Application Publication
(10) Pub. No.: US 2025/0050474 A1
(43) Pub. Date: Feb. 13, 2025

(54) POWER TOOL WITH COUPLING MECHANISM FOR JOINING FIRST AND SECOND HOUSING PORTIONS

(71) Applicant: MILWAUKEE ELECTRIC TOOL CORPORATION, Brookfield, WI (US)

(72) Inventors: Joseph T. Lottes-Paukner, Sussex, WI (US); Joseph J. Drees, Wauwatosa, WI (US); Michael R. Sande, Waukesha, WI (US); Benjamin J. Skelton, Waukesha, WI (US); Scott R. Fischer, Menomonee Falls, WI (US); Minjia Yang, Dongguan City (CN)

(21) Appl. No.: 18/799,556

(22) Filed: Aug. 9, 2024

(30) Foreign Application Priority Data
Aug. 11, 2023 (CN) 202322175204.6

(51) Int. Cl. B25B 21/02; B25F 5/00; B25F 5/02

(52) U.S. Cl. CPC B25B 21/02; B25F 5/001; B25F 5/02

(57) ABSTRACT

A power tool includes a housing having a first housing portion and a second housing portion, the first housing portion and the second housing portion collectively defining a motor housing portion and a handle housing portion, a motor supported within the motor housing portion, the motor including an output shaft defining an axis, a battery removably coupled to the handle housing portion to provide power to the motor, and a coupling mechanism positioned within the motor housing portion to couple the first housing portion and the second housing portion together.

### CROSS-REFERENCE TO RELATED APPLICATIONS

This application claims priority to Chinese Utility Model Application No. 202322175204.6, filed Aug. 11, 2023, the entire content of which is incorporated herein by reference.

### FIELD

The present disclosure relates to power tools, and more particularly to rotary impact tools.

### BACKGROUND

Rotary impact tools are typically utilized to provide a striking rotational force, or intermittent applications of torque, to a tool element or workpiece (e.g., a fastener) to either tighten or loosen the fastener.

### SUMMARY

The present disclosure provides, in one aspect, a power tool including a housing having a first housing portion and a second housing portion, the first housing portion and the second housing portion collectively defining a motor housing portion and a handle housing portion, a motor supported within the motor housing portion, the motor including an output shaft defining an axis, a battery removably coupled to the handle housing portion to provide power to the motor, and a coupling mechanism positioned within the motor housing portion to couple the first housing portion and the second housing portion together.

The present disclosure provides, in another aspect, a power tool including a housing having a first housing portion having a first outer surface, a second housing portion having a second outer surface, and a screw boss defining a bore configured to receive a fastener for coupling the first housing portion and the second housing portion together. The power tool also includes a motor supported within the housing between the first housing portion and the second housing portion, the motor including an output shaft defining an axis, a gear assembly configured driven by the output shaft, the gear assembly including a ring gear, and an impact mechanism driven by the gear assembly, the impact mechanism including a hammer configured to impart rotational impacts on an anvil. The screw boss is formed at a location between the ring gear and the hammer in a direction parallel to the axis.

The present disclosure provides, in another aspect, a power tool including a housing having a first housing portion, a second housing portion, and a screw boss defining a bore configured to receive a fastener for coupling the first housing portion and the second housing portion together. The power tool also includes a motor supported within the housing, the motor including a stator and an output shaft defining an axis, and a gear assembly driven by the output shaft. The bore of the screw boss and the motor are positioned such that a line can be drawn parallel to the axis and through both the bore of the screw boss and the motor.

### BRIEF DESCRIPTION OF THE DRAWINGS

FIG. 1 is a perspective view of a power tool according to an embodiment of the disclosure.

FIG. 2 is a cross-sectional view of the power tool of FIG. 1.

FIG. 3A is a cross-sectional view of a portion of the power tool of FIG. 1 with a hammer for an impact mechanism located in a first position.

FIG. 3B is a cross-sectional view of a portion of the power tool of FIG. 1 with the hammer for the impact mechanism located in a second position.

FIG. 4 is a perspective view of an intermediate case for the power tool of FIG. 1.

FIG. 5 is an enlarged view of the portion of the power tool of FIG. 4 with the hammer for the impact mechanism located in the second position.

FIG. 6 is a cross-sectional view of the power tool taken along line 6-6 in FIG. 1.

FIG. 7 is a perspective view of a portion of the power tool of FIG. 1.

FIG. 8 is a zoomed-in view of a portion of the cross-sectional view of the power tool of FIG. 6.

FIG. 9 is an exploded perspective view of a housing for the power tool of FIG. 1.

FIG. 10 is a perspective view of a portion of another power tool according to an embodiment of the disclosure.

FIG. 11 is another perspective view of a portion of the power tool of FIG. 10.

FIG. 12 is a perspective view of a portion of another power tool according to an embodiment of the disclosure.

FIG. 13 is a cross-sectional view of the portion of the power tool of FIG. 12 taken along line 13-13.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

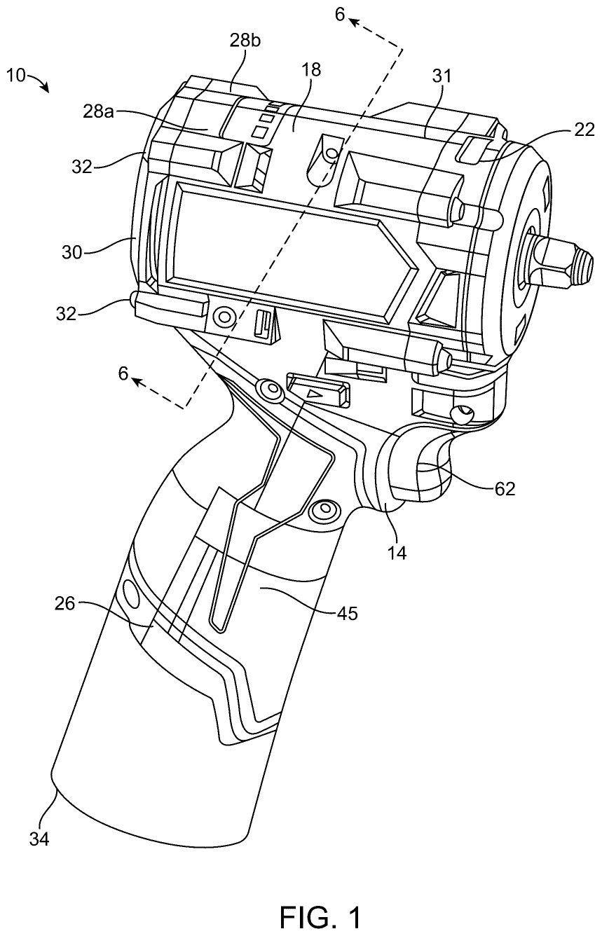

FIG. 1 illustrates an embodiment of a power tool in the form of a rotary impact tool, and, more specifically, an impact wrench 10. The impact wrench 10 includes a housing 14 with a motor housing portion 18, an impact case or front housing portion 22 coupled to the motor housing portion 18, and a handle portion 26 extending downwardly from the motor housing portion 18. In the illustrated embodiment, the handle portion 26 and the motor housing portion 18 are defined by cooperating first and second clamshell halves or housing portions 28a, 28b.

The illustrated housing 14 also includes an end cap 30 coupled to the motor housing portion 18 opposite the front housing portion 22. The clamshell halves 28a, 28b can be coupled (e.g., fastened) together at an interface or seam 31, as will be described in further detail. In the illustrated embodiment, the end cap 30 is continuous and may be pressed or fitted over a rear end of the clamshell halves 28a, 28b. In other words, the end cap 30 may not include two halves such that the end cap 30 may extend over the seam 31. The end cap 30 is coupled to the motor housing portion 18 by a plurality of fasteners 32. In yet other embodiments, the impact wrench 10 may not include a separate end cap, such that the clamshell halves 28a, 28b instead define the rear end of the motor housing portion 18.

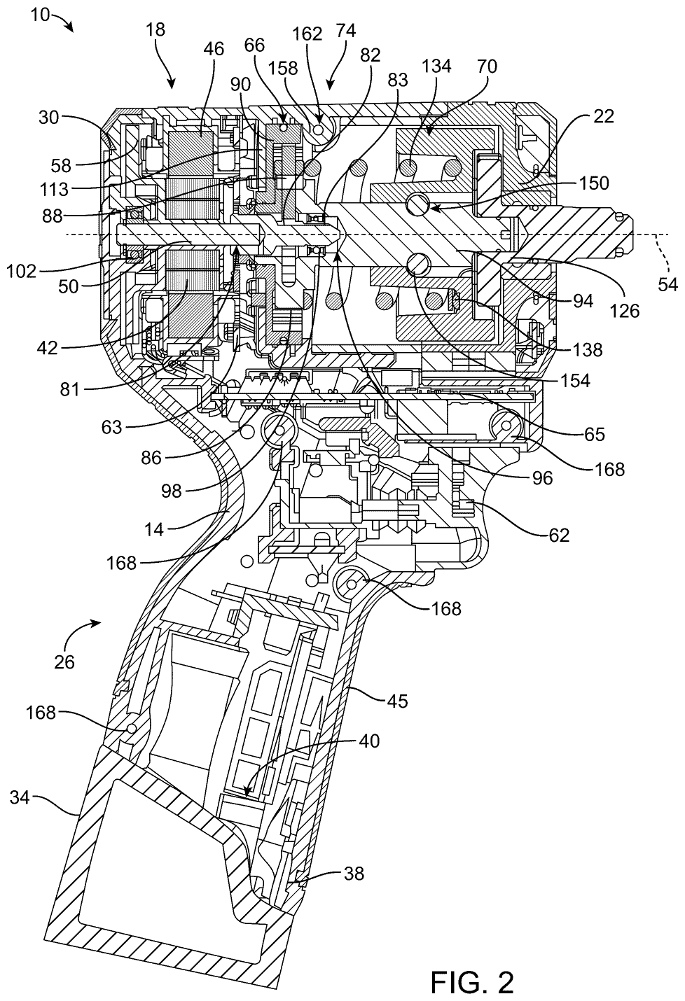

Referring to FIGS. 1 and 2, the impact wrench 10 includes a battery 34 removably coupled to a battery receptacle 38, which in the illustrated embodiment, includes a cavity 40 extending into the handle portion 26. A motor 42 is supported within the motor housing portion 18 and receives power from the battery 34 via connections, pads, and/or battery terminals in the battery receptacle 38 when the battery 34 is coupled to the battery receptacle 38. In the illustrated embodiment, the handle portion 26 of the clamshell halves 28a, 28b can be covered or surrounded by a grip portion 45, which may be overmolded on the handle portion 26.

The battery 34 may be a power tool battery pack generally used to power a power tool, such as an electric drill, an electric saw, and the like (e.g., a 12 volt rechargeable battery pack). The battery 34 may include lithium ion (Li-ion) cells. The 12-volt nominal output voltage of the battery 34 provides an optimal balance between weight/size and power in the illustrated impact wrench 10; however, batteries with other nominal voltages may be used in other embodiments.

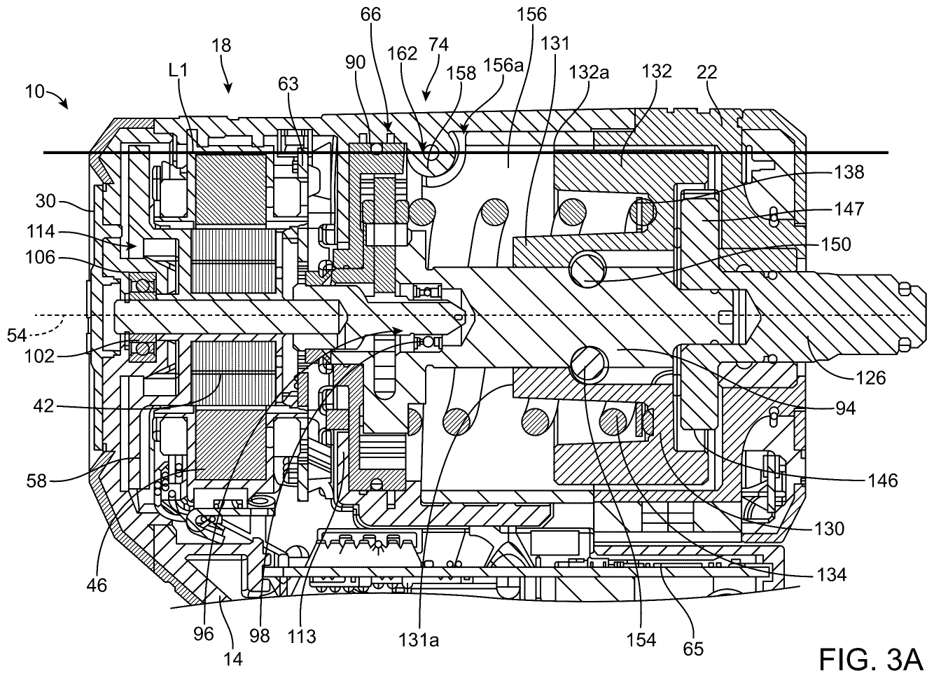

Now referring to FIGS. 2 and 3A, in the illustrated embodiment, the motor 42 is a brushless direct current (“BLDC”) motor with a stator 46 and a rotor with an output shaft 50 that is rotatable about an axis 54 relative to the stator 46. The illustrated brushless motor 42 preferably has a nominal diameter of 50 millimeters, but the diameter of the brushless motor 42 may differ in other embodiments. In yet other embodiments, other types of motors may be used. A fan 58 is coupled to the output shaft 50 behind the motor 42 to generate airflow for cooling the motor 42 and/or other components of the power tool 10.

Referring to FIG. 2, the impact wrench 10 also includes a trigger 62 (including an actuator and a trigger switch) supported by the housing 14 and operable to selectively electrically connects the motor 42 (e.g., via suitable control circuitry provided on one or more printed circuit board assemblies (“PCBAs”) and the battery 34, to provide DC power to the motor 42. In other embodiments, the impact wrench 10 may include a power cord for electrically connecting the trigger 62 and the motor 42 to a source of AC power. As a further alternative, the impact wrench 10 may be configured to operate using a different power source (e.g., a pneumatic or hydraulic power source, etc.).

In the illustrated embodiment, a first PCBA 63 is supported within the motor housing portion 18 adjacent a front end of the stator 46. The illustrated first PCBA 63 extends perpendicular to the axis 54 and includes one or more Hall-Effect sensors, which provide feedback for controlling the motor 42. A second PCBA 65 is supported within housing 14 (e.g., at an upper end of the handle portion 26 or a lower end of the motor housing portion 18) and extends parallel to the axis 54. The second PCBA 65 is in electrical communication with the motor 42, the trigger 62, and terminals of the battery receptacle 38. In the illustrated embodiment, the second PCBA 65 includes a plurality of semi-conductor switching elements (e.g., MOSFETs, IGBTs, or the like) that control and distribute power to windings in the stator 46 in order to cause rotation of the rotor and output shaft 50. The second PCBA 65 may also include one or more microprocessors, machine-readable, non-transitory memory elements, and other electrical or electronic elements for providing operational control to the impact wrench 10. In some embodiments, the first PCBA 63 may be omitted, and the motor 42 may be configured for sensorless control via the second PCBA 65. The positions of the first PCBA 63 and/or the second PCBA 65 within the housing 14 may vary in some embodiments.

Referring now to FIGS. 2 and 3A, the impact wrench 10 further includes a gear assembly 66 driven by the output shaft 50 and an impact mechanism 70 coupled to an output of the gear assembly 66. The impact mechanism 70 may also be referred to herein as a drive assembly 70. The gear assembly 66 may be configured in any of a number of different ways to provide a speed reduction between the output shaft 50 and an input of the drive assembly 70. The gear assembly 66 is at least partially housed within a gear case or gear housing 74, which, in the illustrated embodiment, is formed by the housing 14. In particular, the clamshell halves 28a, 28b (FIG. 1) and the front housing portion 22 collectively define the gear housing 74 in the illustrated embodiment. Accordingly, a ring gear 90 of the gear assembly 66 is directly supported by the clamshell halves 28a, 28b. In other embodiments, the ring gear 90 may be supported by a gear case, which in turn may be supported by the clamshell halves 28a, 28b.

With continued reference to FIGS. 2 and 3A, the gear assembly 66 includes a pinion gear 82 coupled to the output shaft 50 of the motor 42, a plurality of planet gears 86 meshed with the pinion gear 82, and the ring gear 90, which is meshed with the planet gears 86 and rotationally fixed within the housing 14 (specifically, within the gear housing 74). A rearward facing side of the ring gear 90 is seated against a dividing wall 113 formed by the clamshell halves 28a, 28b (FIG. 3A). The dividing wall 113 separates the gear housing 74 from the motor 42. The illustrated pinion gear 82 includes a recess 81 that receives the output shaft 50 and an extension 83. The output shaft 50 may be press fit into the recess 81, or the output shaft 50 and the recess 81 may include cooperating spline patterns or other suitable geometries for coupling the pinion gear 82 for co-rotation with the output shaft 50. In other embodiments, the pinion gear 82 may be integrally formed as a single piece with the output shaft 50.

The planet gears 86 are coupled, via pins 88, to a camshaft 94 of the drive assembly 70 such that the camshaft 94 acts as a planet carrier. Accordingly, rotation of the output shaft 50 rotates the planet gears 86, which then advance along the inner circumference of the ring gear 90 and thereby rotates the camshaft 94. In the illustrated embodiment, the camshaft 94 includes a bore 96 extending partially through the camshaft 94 along the axis 54. The bore 96 is shaped to accommodate and/or receive at least a portion of the pinion gear 82. In the illustrated embodiment, the bore 96 extends only partially through the length of the camshaft 94; however, the bore 96 may extend through the entire length of the camshaft 94, to reduce the weight of the camshaft 94, in other embodiments.

The output shaft 50 is rotatably supported by a first or forward bearing 98 and a second or rear bearing 102. The pinion gear 82, coupled to the output shaft 50, extends through an opening in the dividing wall 113. The impact wrench 10 includes a hub or bearing retainer 106, which may be at least partially integrally formed with the end cap 30 in some embodiments, and which secures the rear bearing 102 both axially (e.g., against forces transmitted along the axis 54) and radially (i.e. against forces transmitted in a radial direction of the output shaft 50). In the illustrated embodiment, the fan 58 includes a recess 114 and the bearing retainer 106 extends into the recess 114 such that at least a portion of the bearing retainer 106 and at least a portion of the rear bearing 102 overlap the fan 58 along the axis 54 (FIG. 2). This overlapping arrangement advantageously reduces the axial length of the impact wrench 10.

The drive assembly 70 of the impact wrench 10 will now be described with reference to FIG. 3A. The drive assembly 70 includes an anvil 126, extending from the front housing portion 22, to which a tool element (e.g., a socket, not shown) can be coupled for performing work on a workpiece (e.g., a fastener). The drive assembly 70 is configured to convert the constant rotational force or torque provided by the gear assembly 66 to a striking rotational force or intermittent applications of torque to the anvil 126 when the reaction torque on the anvil 126 (e.g., due to engagement between the tool element and a fastener being worked upon) exceeds a certain threshold. In the illustrated embodiment of the impact wrench 10, the drive assembly 70 includes the camshaft 94, a hammer 130 supported on and axially slidable relative to the camshaft 94, and the anvil 126. Stated another way, the hammer 130 is configured to reciprocate axially along the camshaft 94 and impart periodic rotational impacts to the anvil 126 in response to rotation of the camshaft 94.

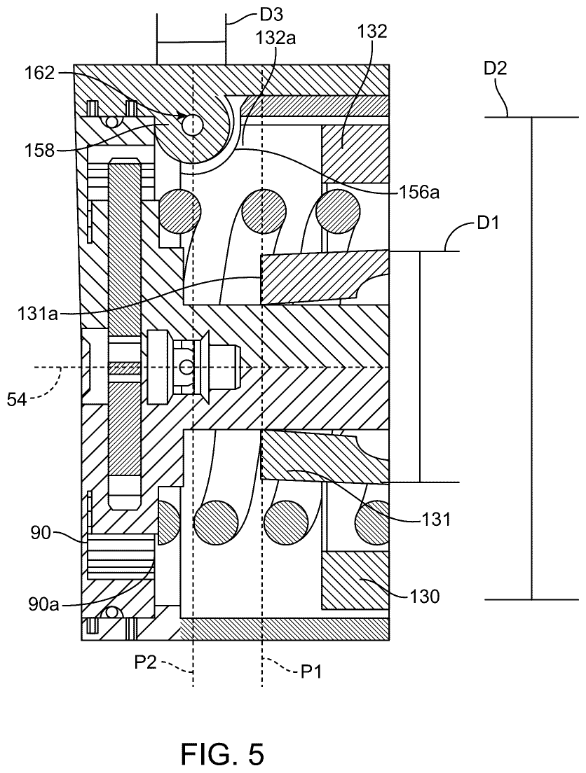

With reference to FIGS. 3A, 3B, and 5, the hammer 130 includes a first hammer portion 131 and a second hammer portion 132. The first hammer portion 131, which is an inner portion of the hammer 130 coupled to the camshaft 94 via the balls 154, defines a rear end 131a of the hammer 130 in a direction along the axis 54. The second hammer portion 132 includes the hammer lugs 146. The second hammer portion 132 surrounds and has a larger outer diameter D2 than an outer diameter D1 of the inner hammer portion 131. In some embodiments, the inner hammer portion 131 may taper, such that the outer diameter D1 of the inner hammer portion 131 may vary.

The drive assembly 70 further includes a spring 134 that biases the hammer 130 toward the front of the impact wrench 10. In other words, the spring 134 biases the hammer 130 in an axial direction toward the anvil 126, along the axis 54. A thrust bearing 138 is positioned between the spring 134 and the hammer 130. The thrust bearing 138 allows for the spring 134 and the camshaft 94 to continue to rotate relative to the hammer 130 after each impact strike when lugs 146 on the hammer 130 engage with corresponding anvil lugs 147 and rotation of the hammer 130 momentarily stops. The camshaft 94 includes cam grooves 150 in which corresponding cam balls 154 are received (although only one cam ball is illustrated in FIG. 3A). The cam balls 154 are in driving engagement with the hammer 130 and movement of the cam balls 154 within the cam grooves 150 allows for relative axial movement of the hammer 130 along the camshaft 94 when the hammer lugs 146 and the anvil lugs 147 are engaged and the camshaft 94 continues to rotate. The axial movement of the hammer 130 compresses the spring 134, which then releases its stored energy to propel the hammer 130 forward and rotate the hammer 130 once the hammer lugs 146 clear the anvil lugs 147.

Referring to FIG. 3A, the gear housing 74 may contain lubricant, such as grease or oil, for coating the gear assembly 66 and/or drive assembly to assist in smooth operation of the impact wrench 10 by minimizing friction between movable components. As such, the impact wrench 10 includes an intermediate case 156 positioned in abutment with the front housing portion 22 at one end of the case 156 and positioned in abutment with interior portions of the motor housing portion 18 at the other end of the case 156. In the illustrated embodiment, the intermediate case 156 is secured between the front housing portion 22 and the gear housing portion 66 with an interference fit that inhibits lubricant from escaping from the gear assembly 66 and the impact mechanism 70. In some embodiments, the impact wrench 10 includes seals (e.g., o-rings) positioned between the intermediate case 156 and the front housing portion 22, and between the intermediate case 156 and the gear housing portion 66 for further inhibiting lubricant from escaping from the gear assembly 66 and the impact mechanism 70.

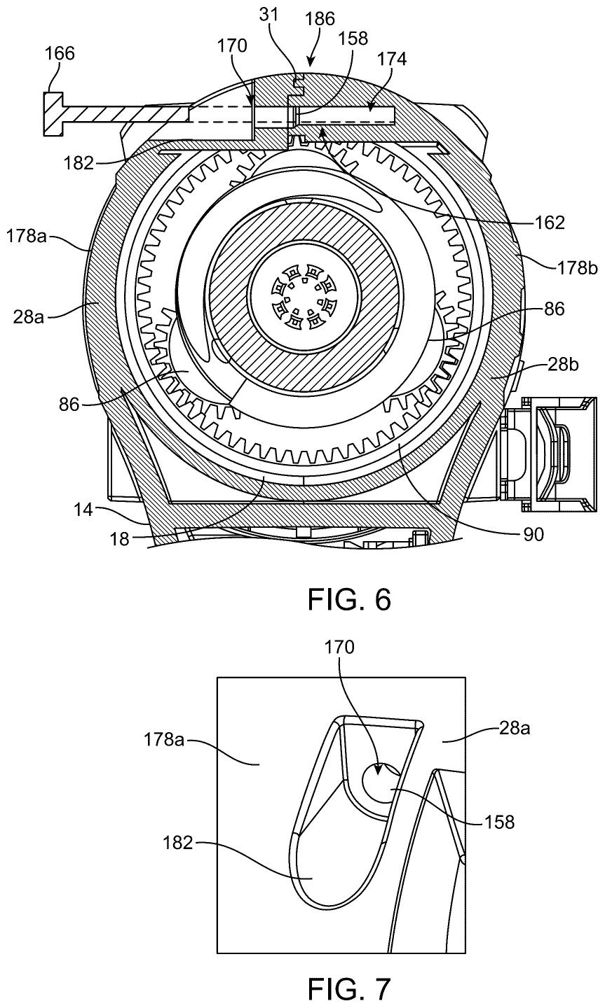

The housing 14 includes a coupling mechanism for coupling the clamshell halves 28a, 28b together. In the illustrated embodiment, as best shown in FIGS. 5 and 6, the clamshell halves 28a, 28b are positioned to at least partially abut one another at the seam 31. When the clamshell halves 28a, 28b are placed in abutment at the seam 31, a screw boss 158 is formed. As such, the coupling mechanism may be a screw boss 158. The screw boss 158 defines a bore 162 that is configured to receive a fastener 166 to secure the clamshell halves 28a, 28b together. The fastener 166 may be threaded, pinned, inserted, etc. into the bore. Returning reference to FIG. 3A, the screw boss 158 is located within the motor housing portion 18 of the housing 14 such that a line L1 may be drawn parallel to the axis 54 that extends through each of the stator 46, the ring gear 90, the hammer 130, and the screw boss 158. In some embodiments, the line L1 may just extend through the screw boss 158 and the stator 46. In further embodiments, the line L1 may extend through the screw boss 158, the stator 46, and the ring gear 90.

When the clamshell halves 28a, 28b are coupled together, the clamshell halves 28a, 28b form the motor housing portion 18 and the handle housing portion 26. The screw boss 158 is positioned within the motor housing portion 18 to improve the compactness of the impact wrench 10 (i.e., as compared the screw boss 158 being positioned on an outer side of the motor housing portion 18). Returning reference to FIG. 2, the clamshell halves 28a, 28b further includes a plurality of handle coupling mechanisms, such as a plurality of handle screw bosses 168, for coupling the clamshell halves 28a, 28b (FIG. 1) together to form the handle housing portion 26. In the illustrated embodiment, the impact wrench 10 includes four handle screw bosses 168.

With reference to FIGS. 6 and 7, the screw boss 158 is formed with an opening 170 in one of the clamshell halves 28a, 28b and an enclosed receptacle 174 in the other of the clamshell halves 28a, 28b. The opening 170 is formed in the one of the clamshell halves 28a, 28b such that the opening 170 extends to an exterior of the housing 14 and the enclosed receptacle 174 is formed such that the enclosed receptacle 174 does not extend to the exterior of the housing 14. In the illustrated embodiment, the opening 170 is recessed from the outer surface 178a, 178b of the one of the clamshell halves 28a, 28b such that the one of the clamshell halves 28a, 28b has a recessed portion 182 that provides clearance for a fastener 166 to be inserted into the opening 170. As such, a fastener 166 may be slid along the recessed portion 182, inserted into the opening 170 in the one of the clamshell halves 28a, 28b, and received in the enclosed receptacle 174 to couple the clamshell halves 28a, 28b together. In other embodiments, the opening 170 may be formed directly on the outer surface 178a, 178b of the one of the clamshell halves 28a, 28b such that the screw boss 158 does not have a recessed portion.

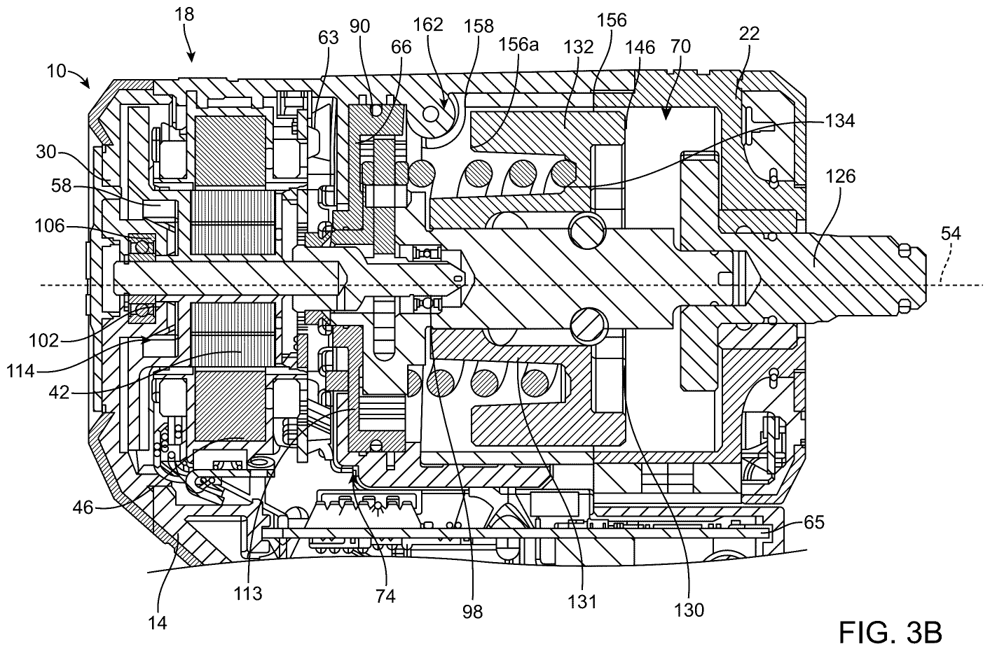

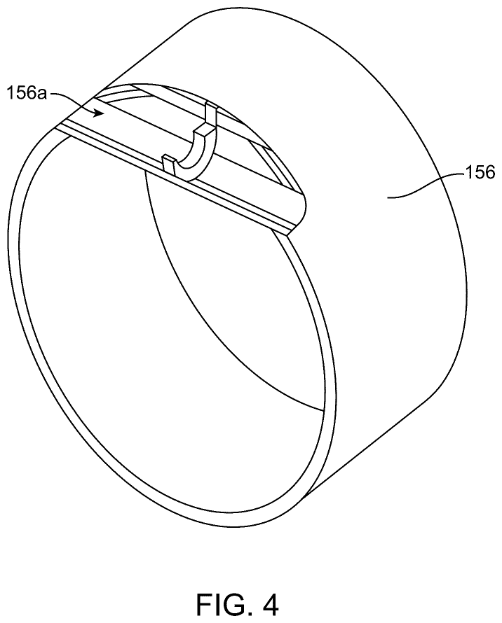

With reference to FIGS. 4 and 5, the intermediate case 156 further includes a case recess 156a. In the illustrated embodiment, the case recess 156a is located at the rear end of the intermediate case 156. In the illustrated embodiment, the case recess 156a is curved and follows the contour of the screw boss 158. As such, the case recess 156a extends around at least a portion of the screw boss 158. In other embodiments, the case recess 156a may not be curved. For example, the case recess 156a may be formed with a right angle. The case recess 156a enables the screw boss 158 to be located between the ring gear 90 and the hammer 130 without increasing the length of the impact wrench 10.

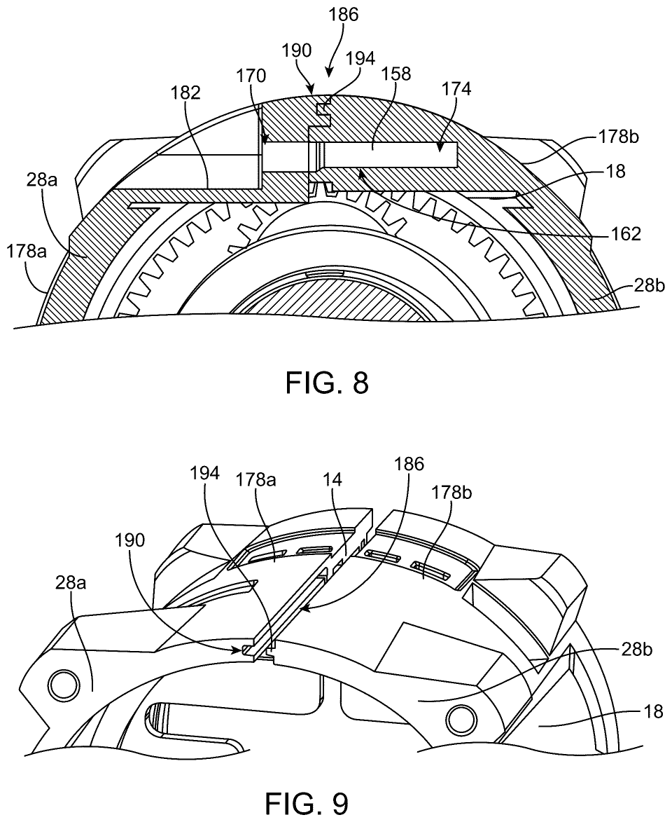

As illustrated in FIGS. 8 and 9, when the clamshell halves 28a, 28b are placed in abutment at the seam 31, an interlocking mechanism 186 is also formed. The interlocking mechanism 186 improves alignment of the clamshell halves 28a, 28b as the clamshell halves 28a, 28b are coupled together. The interlocking mechanism 186 is formed with an elongated slot 190 in one of the clamshell halves 28a, 28b and a protrusion 194 formed on the other of the clamshell halves 28a, 28b. In the illustrated embodiment, the elongated slot 190 is formed on the same clamshell half 28a, 28b as the opening 170, and the protrusion 194 is formed on the same clamshell half 28a, 28b as the enclosed receptacle 174. The protrusion 194 is configured to be received in the elongated slot 190 to improve the ease with which the clamshell halves 28a, 28b are properly aligned relative to one another.

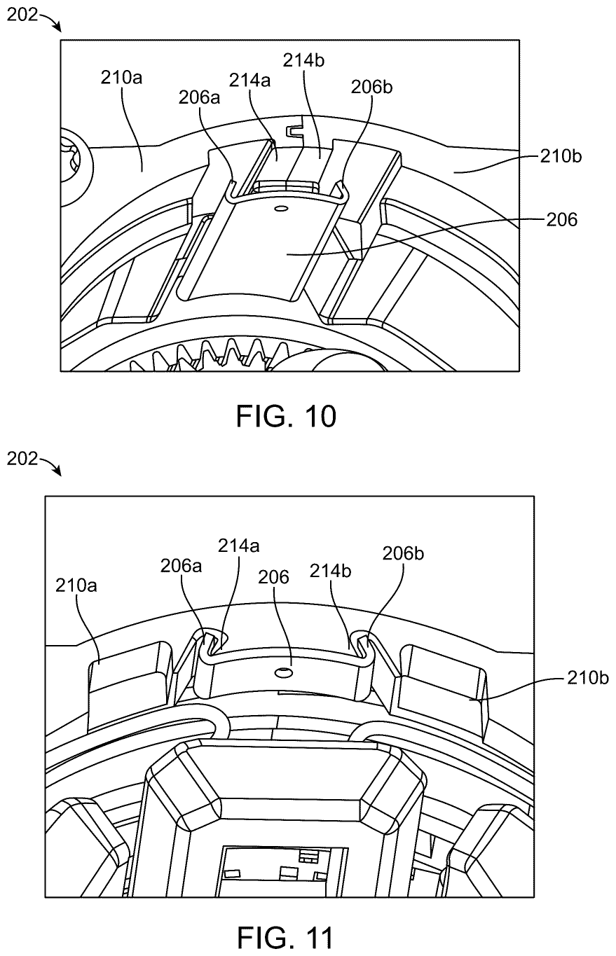

FIGS. 10 and 11 illustrate another embodiment of an impact wrench 202. The impact wrench 202 is substantially similar to the impact wrench 10 of FIG. 1, except for the differences described herein. Features of the impact wrench 202 may be incorporated into the impact wrench 10 where appropriate, and vice versa.

As illustrated in FIGS. 10 and 11, the impact wrench 202 includes a spring clip 206 for coupling clamshell halves 210a, 210b together in place of the screw boss 158 of FIG. 3A. As such, the coupling mechanism for coupling the clamshell halves 210a, 210b may be a spring clip 206. Each clamshell half 210a, 210b includes a coupling protrusion 214a, 214b disposed at an inner face of the clamshell half 210a, 210b. The coupling protrusion 214a, 214b of each clamshell half 210a, 210b extends away from a seam line formed by the clamshell halves 210a, 210b when the clamshell halves 210a, 210b are coupled together. The spring clip 206 includes two flexible end tabs 206a, 206b that may be temporarily deformed around the coupling protrusion 214a, 214b of each clamshell half 210a, 210b for coupling the clamshell halves 210a, 210b together. That is, the flexible end tabs 206a, 206b may be outwardly biased to extend outward of the coupling protrusions 214a, 214b, and then released to induce an inward bias of the flexible end tabs 206a, 206b that provides a clamping force on the coupling protrusions 214a, 214b to couple the clamshell halves 210a, 210b together. In the illustrated embodiment, just one spring clip 206 is provided in place of the screw boss 158. In other embodiments, multiple spring clips 206 may be used in place of or with the screw boss 158. In further embodiments, the impact wrench 10 of FIG. 1 and the impact wrench 202 of FIG. 10 may include any combination of the coupling mechanisms described above.

In some embodiments, the coupling mechanism for coupling the clamshell halves 210a, 210b may be formed with a front housing portion, such as the front housing portion 22 of FIG. 1, of the impact wrench 202. Specifically, the front housing portion may include rearwardly extending protrusions that wedge against the coupling protrusion 214a, 214b of each clamshell half 210a, 210b to provide a clamping force on the coupling protrusions 214a, 214b to couple the clamshell halves 210a, 210b together. As such, the clamshell halves 210a, 210b may be held together by coupling the front housing portion to the clamshell halves 210a, 210b. In other embodiments, the front housing portion may have different features/structures for holding the clamshell halves 210a, 210b together.

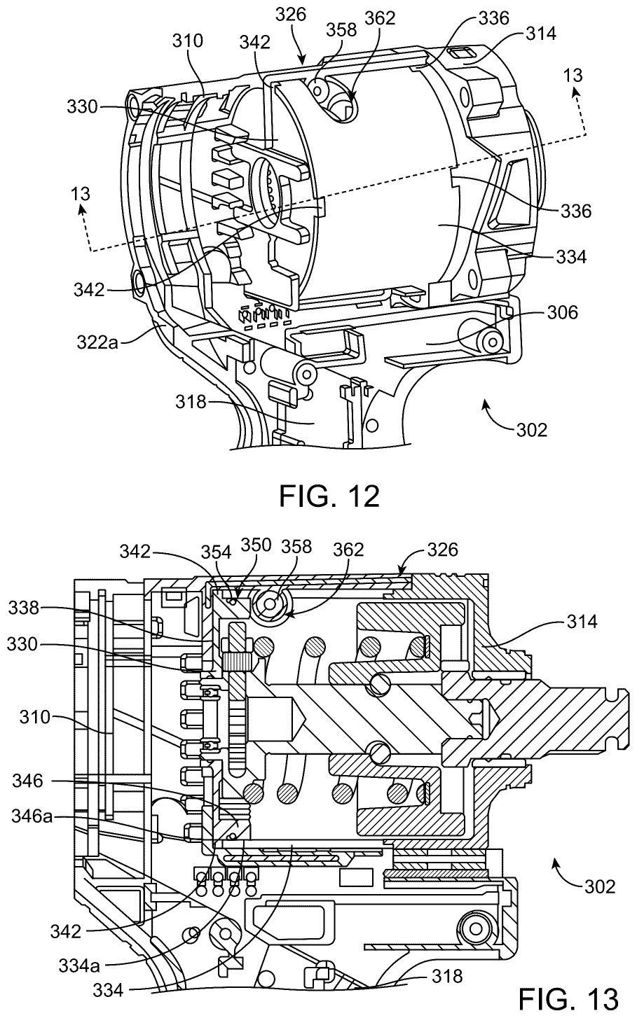

FIGS. 12 and 13 illustrate another embodiment of an impact wrench 302. The impact wrench 302 may be substantially similar to the impact wrench 10 of FIG. 1 or the impact wrench 202 of FIG. 10, except for the differences described herein. Features of the impact wrench 302 may be incorporated into the impact wrench 10 and/or the impact wrench 202 where appropriate, and vice versa.

As illustrated in FIGS. 12 and 13, the impact wrench 302 includes a housing 306 with a motor housing portion 310, an impact case or front housing portion 314 coupled to the motor housing portion 310, and a handle portion 318 extending downwardly from the motor housing portion 310. In the illustrated embodiment, the handle portion 318 and the motor housing portion 310 are defined by cooperating first and second clamshell halves or housing portions 322a, although only one clamshell half 322a is illustrated in FIGS. 12 and 13. The motor housing portion 310 includes a gear housing 326 that houses a ring gear 330 and an intermediate case 334. The intermediate case 334 is secured and rotationally fixed to the front housing portion 314 by a plurality of protrusions 336.

The ring gear 330 is disposed at a rear end of the intermediate case 334, and the intermediate case 334 extends to the front housing portion 314. The ring gear 330 extends at least partially into the intermediate case 334. The ring gear 330 includes a rearward plate 338 that has a diameter that is substantially the same as the intermediate case 334. In the illustrated embodiment, the rearward plate 338 includes a plurality of protrusions 342 disposed around the circumference of the plate 338 that define the diameter of the rearward plate 338 that is substantially the same as the intermediate case 334. The plurality of protrusions 342 are engaged with the intermediate case 334 such that the plurality of protrusions 342 may inhibit the intermediate case 334 from rotating relative to the ring gear 330. The ring gear 330 additionally includes a toothed annular portion 346 that extends forward of the rearward plate 338. The toothed annular portion 346 has a smaller diameter than the intermediate case 334 such that an outer surface 346a of the toothed annular portion 346 abuts an inner surface 334a of the intermediate case 334. The toothed annular portion 346 defines a groove 350 in the outer surface 346a of the toothed annular portion 346. A sealing member 354 is disposed in the groove 350 and may be compressed between the toothed annular portion 346 and the intermediate case 334 to inhibit oil and grease from leaving the intermediate case 334.

A screw boss 358 for coupling the clamshell halves 322a together is positioned between the ring gear 330 and the front housing portion 314. As such, the intermediate case 334 extends past the screw boss 358. In the illustrated embodiment of the FIGS. 12 and 13, the intermediate case 334 includes a case aperture 362 that is substantially circular and surrounds at least a portion of the screw boss 358. In the illustrated embodiment, the case aperture 362 is an opening to the interior of the intermediate case 334. A fastener, such as a screw, may extend through the case recess 362 to reach the screw boss 358 and couple the clamshell halves 322a together. In other embodiments, the case aperture 362 may be a recessed portion of an outer surface of the intermediate case 334 such that the recessed portion does not provide an opening to the interior of the intermediate case 334.

Operation of the impact wrench is described below with respect to the impact wrench 10 of FIG. 1. It is understood that the description of the impact wrench 10 applies equally to the impact wrench 202 of FIG. 10 and the impact wrench 302 of FIG. 12. In operation of the impact wrench 10, an operator depresses the trigger 62 to activate the motor 42, which continuously drives the gear assembly 66 and the camshaft 94 via the output shaft 50. As the camshaft 94 rotates, the cam balls 154 drive the hammer 130 to co-rotate with the camshaft 94, and the drive surfaces of hammer lugs 146 to engage, respectively, the driven surfaces of anvil lugs 147 to provide an impact and to rotatably drive the anvil 126 and the tool element. After each impact, the hammer 130 moves or slides rearward along the camshaft 94, away from the anvil 126, so that the hammer lugs 146 disengage the anvil lugs 147.

As the hammer 130 moves rearward, the cam balls 154 situated in the respective cam grooves 150 in the camshaft 94 move rearward in the cam grooves 150. The spring 134 stores some of the rearward energy of the hammer 130 to provide a return mechanism for the hammer 130. After the hammer lugs 146 disengage the respective anvil lugs 147, the hammer 130 continues to rotate and moves or slides forwardly, toward the anvil 126, as the spring 134 releases its stored energy, until the drive surfaces of the hammer lugs 146 re-engage the driven surfaces of the anvil lugs 147 to cause another impact.

As described above, with reference to FIGS. 3A and 3B, the hammer 130 is configured to move between a forward-most position (FIG. 3A), in which the hammer 130 is engaged with the anvil 126 (e.g., and the time of an impact of the hammer 130 against the anvil 126), and a rearward-most position (FIG. 3B), in which the hammer 130 is retracted out of engagement with the anvil 126 such that the hammer 130 is rotatable relative to the anvil 126, during operation of the impact wrench 10. With reference to FIG. 5, when the hammer 130 is in the rearward-most position, the rear end 131a of the hammer 130 is positioned on a first plane P1 that extends perpendicular to the axis 54. In some embodiments, a distance between the first plane P1 and a second plane P2 extending perpendicular to the axis 54 and centrally through the bore 162 is less than a diameter D3 of the screw boss 158.

Although the disclosure has been described in detail with reference to certain preferred embodiments, variations and modifications exist within the scope and spirit of one or more independent aspects of the disclosure as described. For example, although the power tool is described and illustrated herein as an impact wrench 10, 202, aspects of the present disclosure, including but not limited to the coupling mechanisms, may be implemented in other types of power tools, such as drills, powered screwdrivers, impact drivers, rotary hammers, ratchets, grinders, precision torque tools, and the like.

Various features of the present disclosure are set forth in the following claims.

What is claimed is:

1. A power tool comprising:
a housing including a first housing portion and a second housing portion, the first housing portion and the second housing portion collectively defining a motor housing portion and a handle housing portion;
a motor supported within the motor housing portion, the motor including an output shaft defining an axis;
a battery removably coupled to the handle housing portion to provide power to the motor; and
a coupling mechanism positioned within the motor housing portion to couple the first housing portion and the second housing portion together.

2. The power tool of claim 1, wherein the coupling mechanism includes a screw boss extending through both the first housing portion and the second housing portion, the screw boss configured to receive a fastener for securing the first housing portion and the second housing portion together.

3. The power tool of claim 2, wherein the screw boss includes an opening formed in one of the first housing portion or the second housing portion and an enclosed receptacle formed in the other of the first housing portion or the second housing portion.

4. The power tool of claim 1, wherein the first housing portion includes a first coupling protrusion, and the second housing portion includes a second coupling protrusion, and wherein the coupling mechanism includes a clip that is configured to apply a biasing force on each of the first coupling protrusion and the second coupling protrusion in the direction of the other of the first coupling protrusion and the second coupling protrusion to clamp the first coupling protrusion and the second coupling protrusion together, thereby coupling the first housing portion and the second housing portion together.

5. The power tool of claim 1, further comprising:
a gear assembly driven by the output shaft; and
an impact mechanism driven by the gear assembly, the impact mechanism configured to apply periodic rotational impacts to a workpiece,
wherein the gear assembly includes a ring gear,
wherein the impact mechanism includes a hammer, and
wherein the coupling mechanism is disposed axially between the ring gear and the hammer.

6. The power tool of claim 1, further comprising a plurality of handle coupling mechanisms located within the handle housing portion and configured to couple the first housing portion and the second housing portion together, and wherein each of the plurality of handle coupling mechanism is positioned on a side of the axis opposite from the coupling mechanism positioned within the motor housing portion.

7. The power tool of claim 1, further comprising an interlocking mechanism having a protrusion formed on one of the first housing portion and the second housing portion and an elongated slot formed in the other of the first housing portion and the second housing portion, and wherein the elongated slot is configured to receive the protrusion to align the first housing portion and the second housing portion.

8. A power tool comprising:
a housing including
a first housing portion having a first outer surface,
a second housing portion having a second outer surface, and
a screw boss defining a bore configured to receive a fastener for coupling the first housing portion and the second housing portion together,
a motor supported within the housing between the first housing portion and the second housing portion, the motor including an output shaft defining an axis;
a gear assembly configured driven by the output shaft, the gear assembly including a ring gear; and
an impact mechanism driven by the gear assembly, the impact mechanism including a hammer configured to impart rotational impacts on an anvil;
wherein the screw boss is formed at a location between the ring gear and the hammer in a direction parallel to the axis.

9. The power tool of claim 8, wherein the screw boss includes an opening defined in one of the first housing portion and the second housing portion, the opening extending to an exterior of the housing such that the opening extends through a corresponding one of the first outer surface and the second outer surface, and an enclosed receptacle in the other of the first housing portion and the second housing portion, and wherein the enclosed receptacle does not extend through the first outer surface or the second outer surface.

10. The power tool of claim 9, wherein the opening is formed in a recessed portion of the corresponding one of the first outer surface and the second outer surface, the recessed portion providing clearance for a fastener to be inserted into the opening.

11. The power tool of claim 8, wherein the hammer moves between a forward-most position engaged with the anvil and a rearward-most position disengaged from the anvil, wherein the screw boss has a screw boss diameter, and wherein, when the hammer is in the rearward-most position, a distance between a rear end of the hammer and a center of the bore in the screw boss is less than a diameter of the screw boss.

12. The power tool of claim 8, wherein the bore of the screw boss, the motor, and the ring gear are positioned such that a line can be drawn parallel to the axis and through the bore of the screw boss, the motor, and the ring gear.

13. The power tool of claim 8, wherein the housing further includes an intermediate case positioned in front of the ring gear, and wherein the intermediate case has a recess that extends around at least a portion of the screw boss.

14. The power tool of claim 8, wherein the first housing portion includes a first coupling protrusion, and the second housing portion includes a second coupling protrusion, the power tool further comprising a clip that is configured to apply a biasing force on each of the first coupling protrusion and the second coupling protrusion in the direction of the other of the first coupling protrusion and the second coupling protrusion to clamp the first coupling protrusion and the second coupling protrusion together, thereby coupling the first housing portion and the second housing portion together.

15. The power tool of claim 8, further comprising an interlocking mechanism having a protrusion formed on one of the first housing portion and the second housing portion and an elongated slot formed in the other of the first housing portion and the second housing portion, and wherein the elongated slot is configured to receive the protrusion to align the first housing portion and the second housing portion.

16. A power tool comprising:
a housing including
a first housing portion,
a second housing portion, and
a screw boss defining a bore configured to receive a fastener for coupling the first housing portion and the second housing portion together;
a motor supported within the housing, the motor including a stator and an output shaft defining an axis; and
a gear assembly driven by the output shaft;
wherein the bore of the screw boss and the motor are positioned such that a line can be drawn parallel to the axis and through both the bore of the screw boss and the motor.

17. The power tool of claim 16, wherein the gear assembly includes a ring gear, and wherein the ring gear is positioned such that the line extends through the ring gear.

18. The power tool of claim 17, further comprising an impact mechanism having a hammer and an anvil, and wherein the hammer is positioned such that the line extends through the hammer.

19. The power tool of claim 16, further comprising an interlocking mechanism, the interlocking mechanism having a protrusion formed on one of the first housing portion and the second housing portion and an elongated slot formed in the other of the first housing portion and the second housing portion, and wherein the elongated slot is configured to receive the protrusion to align the first housing portion and the second housing portion.

20. The power tool of claim 16, wherein the housing receives a battery that is configured to provide power to the motor, wherein the screw boss is a first screw boss of a plurality of screw bosses, and wherein the first screw boss is the only screw boss of the plurality of screw bosses positioned on a side of the axis that is opposite from the battery.
